(19) United States
(12) Patent Application Publication
(10) Pub. No.: US 2007/0087884 A1
(43) Pub. Date: Apr. 19, 2007

(54) HYBRID ENGINE

(75) Inventor: Peter Janssen, Maasbracht (NL)

Correspondence Address: GIFFORD, KRASS, GROH, SPRINKLE & CITKOWSKI, P.C, PO BOX 7021, TROY, MI, 48007-7021, US

(73) Assignee: FEV MOTORENTECHNIK GMBH, Aachen (DE)

(21) Appl. No.: 11/461,860

(22) Filed: Aug. 2, 2006

(30) Foreign Application Priority Data
Feb. 2, 2005 (WO) PCT/EP05/01012
Feb. 2, 2004 (DE) DE 102004005349.9

(51) Int. Cl. F16H 3/72

(52) U.S. Cl. 475/5

(57) ABSTRACT

The invention relates to a hybrid engine comprising an internal combustion engine (E) and an electric engine (EM), which are connected to each other by means of a planetary gear. A clutch (5) is arranged in such a way that the internal combustion engine and the electric engine are connected to each other by means of a sun wheel and a planetary carrier (6). The invention also relates to a method for operating said hybrid engine.

### FIELD OF TEE INVENTION

The present invention pertains to a hybrid engine with an internal combustion engine and an electric motor that connect to one another by means of a planetary gear. The invention also proposes a method for operating such a hybrid machine.

### BACKGROUND OF THE INVENTION

Numerous hybrid concepts with specific advantages and disadvantages have been proposed so far. Most of these systems have a complicated construction and provide advantages over conventional drive trains only in certain operating points. These concepts are frequently optimized for the consumption cycle only. In normal road traffic, however, significantly fewer advantages are attained. Automatic and automated transmissions were already used in these concepts.

For example, DE 100 36 966 A1 discloses a hybrid engine design with a planetary gear train featuring several interlinks, transmissions and clutches in order to connect an electric motor and an internal combustion engine. DE 100 49 514 A1 also discloses a hybrid engine with an electric motor and an internal combustion engine. Two clutches as well as a brake are integrated into the planetary gear, wherein the electric motor can be rigidly coupled to the internal combustion engine with the aid of the first clutch and the second clutch.

### SUMMARY OF THE INVENTION

The present invention is based on the objective of making available a compact hybrid engine as well as a method for its operation.

This objective is attained with a hybrid engine with the characteristics of Claim 1, as well as a method for operating a hybrid engine with the characteristics of Claim 19. Other advantageous embodiments and additional developments are disclosed in the respective subordinate claims.

The invention proposes a hybrid engine with an internal combustion engine and an electric motor that connect to one another by means of a planetary gear, wherein a clutch is arranged such that the internal combustion engine and the electric motor are connected to one another by means of a sun wheel and a planetary carrier. The clutch is preferably arranged between a clutch of a transmission input, particularly of an automatic transmission, and the planetary gear. According to another characteristic, the invention proposes a hybrid engine with an internal combustion engine and with an electric motor that can be interlocked by means of a clutch and that are connected to one another by means of a planetary gear, wherein the planetary gear features double planetary carriers.

According to one additional development, the invention proposes a hybrid engine with an internal combustion engine and with an electric motor that connect to one another by means of a planetary gear, wherein the internal combustion engine and the electric motor can be interlocked by means of a sun wheel and a planetary carrier when this clutch is actuated. The clutch is preferably arranged between the automatic transmission and the planetary gear.

The clutch is preferably integrated into the planetary gear, wherein the clutch is surrounded by a ring gear of the planetary gear. According to one embodiment, the ring gear is supported on a shaft that is directly connected to a transmission input of the automatic transmission. The shaft preferably forms the transmission input. According to another embodiment, the clutch directly connects the sun wheel and the transmission input of the automatic transmission to one another.

The invention also proposes that the internal combustion engine be connected to the sun wheel and that the electric motor be connected to a planetary carrier. According to another embodiment, the electric motor is connected to the sun wheel and the internal combustion engine is connected to the planetary carrier.

The proposed solution connects the internal combustion engine, the electric motor and the transmission by means of a planetary gear set that is arranged upstream of the automatic transmission. Although the inventive concept is described below in an exemplary fashion with reference to an application with a CVT transmission, it could be used analogously in connection with other transmission and engine concepts. The concept may be utilized in the form of a starting element with high torque amplification (geared neutral concept), a starter, a generator, a booster, a hillholder, a reverse gear, as well as for regenerative braking. In addition, the system largely behaves like a system without inertia during a significant portion of the starting process.

The transmission has a planetary gear set that preferably features double planetary carriers. However, it would also be possible to provide a succession of planetary carriers between the sun wheel and the ring gear. The sun wheel is connected to the internal combustion engine, the planetary carrier is connected to the electric motor, and the ring gear is connected to a variator of the automatic transmission. The arrangement of the internal combustion engine and the electric motor as well as the design of the planetary gear set can be optionally varied. In the following description, in particular, of the enclosed figures the chosen transmission ratio of the planetary gear set from the sun wheel to the ring gear was at −1. This transmission ratio can also be appropriately adapted depending on the respective requirements.

Preferably, the automatic transmission is directly connected to a shaft of the clutch without an intermediate torque converter. The invention also proposes that an electric oil pump be optionally utilized for supplying the automatic transmission with oil. The electric motor serves, in particular, at least as a starter and as a booster. Preferably, the electric motor is also suitable for use as a generator. The electric motor is designed, in particular, in the form of a 4-quadrant machine. This makes it possible for the electric motor to turn in different directions such that it can be used, respectively, as a generator or as a drive mechanism.

According to another embodiment, the hybrid engine features an automatic transmission without a reverse gear. The connection between the electric motor, the internal combustion engine, the planetary gear and the clutch, as well as the coupling to the transmission input, make it possible to change the rotational direction of the transmission input by varying the rotational speed of the electric motor. Consequently, it is possible to reverse by means of the electric motor only, particularly by its adjustment. The hybrid engine preferably features a crankshaft of the internal combustion engine with a free-wheel. This enables the electric motor to turn in a different direction than the internal combustion engine. This can be utilized, e.g. when reversing the vehicle. For example, this makes it possible to realize a purely electric driving mode.

According to one additional development, an arrangement for monitoring the operating state of the battery is provided. For example, the monitoring arrangement is designed such that the battery always contains a minimum of stored energy for reversing and for several starling processes. In this respect, it would be possible, in particular, to monitor a minimum of a value that is characteristic of the charge status of the battery, for example, a voltage or capacity. In this case, one or more values may be predefined such that the battery can be at least partially recharged in a timely fashion. It would even be possible to connect two or more energy accumulators in parallel or in series so as to ensure a sufficient energy supply of the electric motor and to make available a sufficient storage capacity. Furthermore, an ambient temperature can be incorporated into monitoring of the battery status. This makes it possible to predefine different values for a winter mode and a summer mode.

The hybrid engine is preferably used in a vehicle, particularly a land vehicle. In this case, the hybrid engine preferably features a starter in the form of an electric motor, a generator in the form of an energy accumulator such as, for example, a battery, and an electronic parking brake or brake acting upon the clutch.

According to another aspect, the invention proposes a method for operating a hybrid engine with an internal combustion engine and an electric motor that are coupled to one another by means of a planetary gear, wherein the electric motor is used for starting the internal combustion engine when an automatic transmission connected to the planetary gear is locked. According to another characteristic of the method for operating a hybrid engine during a starting process of the internal combustion engine, the internal combustion engine is started by engaging a clutch. For this purpose, the hybrid engine features a connection of the electric motor, the internal combustion engine, the planetary gear and the clutch, as well as a coupling with a transmission input. According to one embodiment, the internal combustion engine is started in the electric driving mode by engaging the clutch. According to another embodiment, it is proposed that during the starting process a released inertial energy be used for starting the internal combustion engine as torque-neutrally as possible. The torque of the electric motor is preferably lowered during the starting process as a function of a transmission ratio, in particular by one-half.

Other proposed operating modes of the hybrid engine can be respectively realized independently of the process of starting the hybrid engine. For example, the invention proposes that the speed of the internal combustion engine be varied by adjusting the speed of the electric motor. It would also be possible to vary the speed of a transmission input to the automatic transmission by adjusting the speed of the electric motor. According to another embodiment, a clutch arranged between a transmission input of the automatic transmission and the planetary gear is engaged after a speed of the electric motor has been varied, preferably increased, particularly to such a degree that it at least approximately corresponds to the speed of the internal combustion engine. In all applications, the electric motor preferably can also be used as a generator. For this purpose, a control is provided that determines whether the system should be switched from the generator mode to the electric motor mode or vice versa, based on a load status of the internal combustion engine. However, it would also be possible to utilize other parameters for realizing such a change of the operating mode, for example, the battery status, an actuation of the accelerator and/or the brake pedal, etc.

According to another operating mode of the hybrid engine, the automatic transmission is down-shifted and the speed of the electric motor is increased to realize regenerative braking. This makes it possible to reduce an effective moment that can be absorbed by the higher speed of the electric motor. In another operating mode, the speed of the electric motor is varied to realize a chance in the rotational direction of a transmission input of the automatic transmission, namely until the transmission input changes rotational direction.

### BRIEF DESCRIPTION OF THE DRAWING

Other advantageous embodiments and additional developments are described in greater detail below with reference to the enclosed figures. However, the characteristics illustrated in the figures should not be understood in a restrictive sense. On the contrary, other embodiments can be realized by combining these characteristics with one another, as well as with the above-described characteristics. The figures show:

FIG. 1, a first embodiment of a hybrid engine;

FIG. 2, a planetary gear in a first operating mode;

FIG. 3, the planetary gear according to FIG. 2 in a second operating mode;

FIG. 4, the planetary gear according to FIG. 3 in a third operating mode;

FIG. 5, a second embodiment of a hybrid engine;

FIG. 6, an exemplary first illustration of the speed dependencies among the electric motor, the internal combustion engine and the transmission input;

FIG. 7, an exemplary second illustration of the speed dependencies among the electric motor, the internal combustion engine and the transmission input;

FIG. 8, an exemplary third illustration of the speed dependencies among the electric motor, the internal combustion engine and the transmission input;

FIG. 9, the planetary gear according to FIG. 1 in a fourth operating mode;

FIG. 10, an exemplary fourth illustration of the speed dependencies among the electric motor, the internal combustion engine and the transmission input;

FIG. 11, an exemplary fifth illustration of the speed dependencies among the electric motor, the internal combustion engine and the transmission input, and

FIG. 12, the planetary gear according to FIG. 1 in a fifth operating mode.

### DETAILED DESCRIPTION OF THE INVENTION

FIG. 1 shows a hybrid engine 1 with an internal combustion engine E and an electric motor EM. An automatic transmission AT is arranged opposite of the electric motor EM and the internal combustion engine E. An electric oil pump EP is assigned to the automatic transmission in order to supply it with oil. A planetary gear features a planetary gear set with double planet wheels 3, 4. A sun wheel 5 is connected to the internal combustion engine E, a planetary carrier 6 is connected to the electric motor EM, and a ring gear 7 is connected to a shaft, in particular to a variator of the automatic transmission AT as a transmission input 8. The ring (ear 7 comprises a clutch C that produces a connection between the transmission input 8 and the sun wheel 5. If the clutch C is engaged, the internal combustion engine E and the electric motor are interlocked. The clutch C may be realized in the form of a dry clutch or a wet clutch. The arrangement of the internal combustion engine E and the electric motor EM as well as the design of the planetary gear set may be optionally modified. With respect to the planetary gear set described below, the chosen transmission ratio from the sun wheel 5 to the ring gear 7 was at −1. However, this transmission ratio can also be adapted to the respective requirements. Individual operating states of the system are described below with reference to the other figures.

FIG. 2 shows a horizontal projection of the planetary gear 2. This planetary gear features, for example, six planet wheels 3, 4. However, a larger number of planet wheels may also be provided. This horizontal projection reflects an operating state that occurs, for example, when the vehicle is at a standstill and/or when starting the hybrid engine. The rotation of the ring gear 7 and therefore the transmission input have the value zero. The sun wheel 5 and therefore the internal combustion engine have a rotational speed with the value n. The planet wheels 3, 4 have a rotational speed such that the speeds of the electric motor and of the internal combustion engine are identical, however, with opposite preceding signs. In the design of the hybrid engine, this makes it possible to at least approximately achieve a torque for the transmission input that is composed in equal shares of a torque of the electric motor and of a torque of the internal combustion engine.

FIG. 3 shows the state when the vehicle is started. In this case, the ring gear rotates with a speed other than zero.

FIG. 4 shows an operating state while driving. The electric motor and the internal combustion engine preferably have the same rotational speed. Slip preferably does not occur.

FIG. 5 shows a schematic representation of a second hybrid engine 9. Components identical to FIG. 1 are identified by the same reference symbols. The automatic transmission AT features neither an upstream torque converter nor a reverse gear. It is preferably realized in the form of a CVT transmission. The second hybrid engine furthermore features a free-wheel 10. The free-wheel enables the internal combustion engine to turn in one direction only, particularly toward the right. In addition, the second hybrid engine features an electric parking brake or brake, which is indicated by an arrow 11. The electric parking brake is preferably integrated into the automatic transmission AT or at least coupled to it.

FIG. 6 shows an exemplary first illustration of the speed dependencies among the electric motor EM, the internal combustion engine E and the transmission input 8, namely for standstill and an engine start at standstill. If the vehicle is at standstill, the electric parking brake (brake) is automatically engaged. This causes the drive of the transmission to be locked. If the electric motor now rotates toward the left, the internal combustion engine is inevitably rotated toward the right and therefore can be started. After the engine starts, the battery can also be charged in P or N because the moment can be absorbed by the parking brake/brake.

FIG. 7 shows an exemplary second illustration of the speed dependencies among the electric motor EM, the internal combustion engine E and the transmission input 8, namely when starting from standstill and for a constant driving mode. If the current in the electric motor is lowered to 0, the vehicle remains at standstill when the brake is disengaged. A creeping tendency may also be optionally applied. When starting from standstill, the E-engine speed is initially lowered to 0. This causes the transmission input 8 to rotate, for example, with half the motor speed, depending on the transmission ratio. The driving torque is the sum of the motor torque and the E-engine torque. The inertial energy released when the E-engine speed is reduced can be directly utilized for accelerating the internal combustion engine. If the inertia of masses is about identical, the system behaves like a system with no inertia (zero inertia driveline) in this phase, and therefore solves the previously existing starting problems in so-called “geared neutral” systems.

The speed transmission ratio decreases to 2 in this phase, depending on the respectively chosen transmission ratio. In this case, it needs to be observed that the torques of the electric motor and of the internal combustion engine are identical in this operating point. The driving torque decreases to the sum of the torques of both drives in this case.

In the second phase of the starting process, the speed of the electric motor is raised to approximately the engine speed by means of electric boosting. The lockup clutch C is now connected at approximately 0 rpm slip. The complete system is interlocked after the clutch has been engaged. The electric motor can now continue to operate as a booster or be selectively operated as a generator. In this operating state, the function is comparable to that of a conventional starter/generator system, particularly a system in which a crankshaft is utilized as the starter.

FIG. 8shows an exemplary third illustration of the speed dependencies among the electric motor EM, the internal combustion engine E and the transmission input 8, namely when reversing. If the speed of the electric motor is additionally lowered rather than reduced to 0 when starting from standstill, the pole of the transmission input shifts below 0 rpm such that the transmission input rotates backward and the vehicle can be reversed. This means that the conventional planetary gear set of a CVT transmission with forward and reverse clutch can be completely eliminated. The elimination of the reversing elements in the transmission also applies if another transmission concept is arranged downstream. According to this concept, the system is up-shifted in reverse or started in a higher gear because the low reverse transmission ratio would otherwise allow only a limited reversing speed.

FIG. 9 shows the planetary gear according to FIG. 1 in an operating mode, for example, in which reversing can be realized.

FIG. 10 shows an exemplary fourth illustration of the speed dependencies among the electric motor EM, the internal combustion engine E and the transmission input 8, namely during regenerative braking. As soon as the vehicle is subjected to thrust, the lockup clutch can be released. This causes the internal combustion engine to drop to the idling speed. The speed of the electric motor consequently increases. If the automatic transmission is also down-shifted, the speed of the electric motor can be additionally increased. This makes it possible to tap smaller torques. The tapped torque of the electric motor is limited by the thrust moment of the internal combustion engine.

FIG. 11 shows an exemplary fifth illustration of the speed dependencies among the electric motor EM, the internal combustion engine E and the transmission input 8, namely in the electric driving mode and for engine start while driving. The concept is optionally equipped with a free-wheel on the crankshaft of the internal combustion engine. This additional device makes it possible to drive in a purely electric mode by acting upon the electric motor with a positive rotational speed. Should the internal combustion engine also be started in the electric driving mode, it suffices to merely engage the lockup clutch. During the connecting process, the speed of the electric motor drops by one-half. The inertial energy released during this process can be effectively utilized for starting the internal combustion engine with a largely neutral torque (relative to the driving torque).

FIG. 12 shows the planetary gear according to FIG. 1 in a fifth operating mode, particularly in the regenerative braking mode.

The internal combustion engine can be freely started and shut off by combining the aforementioned operating strategies. Under given vehicle conditions (electric power-steering, etc.), the engine can also be shut off while driving.

The invention proposes a simple hybrid concept with nearly all degrees of freedom as described under 3. Table 1 shows which components were eliminated from and added to the drive train, for example, with a CVT transmission.

TABLE 1
Comparison between hybrid system and conventional system

| | |
|---|---|
| Neue Komponenten \textcircled{1} | Entfallende Komponenten \textcircled{6} |
| Elektromotor \textcircled{2} | Anlasser \textcircled{7} |
| Energiespelcher (z.B. Batteria) \textcircled{3} | Lichtmaschine \textcircled{8} |
| Leistungselektronik \textcircled{4} | Drehmornentwandler mil |
| Elektronische Parksperre/Bremse \textcircled{5} | Überbrücku \textcircled{9} |
| | Kupplung vorwärts \textcircled{10} |
| | Kupplung Rückwärts \textcircled{11} |
| | Fahrzeugbatterie \textcircled{12} |

Key:
\textcircled{1} New components
\textcircled{2} Electric motor
\textcircled{3} Energy storage (e.g., battery)
\textcircled{4} Power electronics
\textcircled{5} Electronic parking brake/brake
\textcircled{6} Eliminated components
\textcircled{7} Starter
\textcircled{8} Generator
\textcircled{9} Torque converter with lockup
\textcircled{10} Forward clutch
\textcircled{11} Reverse clutch
\textcircled{12} Vehicle battery

The planetary gear set normally used for reversing is configured differently in the new concept, and now functions as a starting element.

The comparison shows that the concept can be largely realized in a weight-neutral and cost-neutral fashion because a few expensive and heavy components (converter, clutches, battery) are no longer required.

1. A hybrid engine with an internal combustion engine and an electric motor that are connected to one another by means of a planetary gear, wherein a clutch is arranged such that the internal combustion engine and the electric motor are connected to one another by means of a sun wheel and a planetary carrier, wherein the sun wheel is connected to the electric motor and the internal combustion engine is connected to the planetary carrier, and wherein the crown wheel is supported on a shaft that is directly connected to a transmission input of an automatic transmission.

2. The hybrid engine with an internal combustion engine and an electric motor according to claim 1, characterized by the fact that the internal combustion engine and the electric motor can be interlocked by means of a clutch and are connected to one another by means of a planetary gear, wherein the planetary gear features double planetary carriers.

3. The hybrid engine according to claim 1, characterized by the fact that the clutch is arranged such that the internal combustion engine and the electric motor are interlocked by means of a sun wheel and a planetary carrier when this clutch is actuated.

4. The hybrid engine according to claim 1, characterized by the fact that the clutch is arranged between a coupling to a transmission input, particularly of an automatic transmission, and the planetary gear.

5. The hybrid engine according to claim 1, characterized by the fact that the clutch is arranged between the automatic transmission and the planetary gear.

6. The hybrid engine according to claim 1, characterized by the fact that the clutch is integrated into the planetary gear.

7. The hybrid engine according to claim 1, characterized by the fact that a planetary gear set is arranged upstream of an automatic transmission.

8. The hybrid engine according to claim 1, characterized by the fact that the clutch directly connects the sun wheel and the transmission input of the automatic transmission to one another.

9. The hybrid engine according to claim 1, characterized by the fact that the automatic transmission is a CVT transmission.

10. The hybrid engine according to claim 1, characterized by the fact that the automatic transmission is directly connected to a shaft of the clutch without an intermediate torque converter.

11. The hybrid engine according to claim 1, characterized by the fact that an electric oil pump is used for supplying the automatic transmission with oil.

12. The hybrid engine according to claim 1, characterized by the fact that the electric motor serves at least as a starter and as a booster.

13. The hybrid engine according to claim 1, characterized by the fact that the automatic transmission is realized without a reverse gear.

14. The hybrid engine according to claim 1, characterized by the fact that a crankshaft of the internal combustion engine is provided with a free-wheel.

15. The hybrid engine according to claim 1 in a vehicle, characterized by the fact that the electric motor serves as a starter, an energy storage, a generator and an electronic parking brake or brake acting upon the clutch.

16. The hybrid engine according to claim 1 in a vehicle, characterized by a connection of the electric motor, the internal combustion engine, the planetary gear and the clutch as well as a coupling to a transmission input, wherein a change in the rotating direction of the transmission input can be achieved by varying the speed of the electric motor, and wherein reversing can be realized by adjusting the electric motor only.

17. A method for operating a hybrid engine, in particular, according to claim 1 with an internal combustion engine and an electric motor that are coupled to one another by means of a planetary gear, wherein the electric motor is used for starting the internal combustion engine when an automatic transmission connected to the planetary gear is blocked.

18. A method for operating a hybrid engine, particularly according to claim 17, while starting the internal combustion engine, wherein the hybrid engine features a connection of the electric motor, the internal combustion engine, the planetary gear and the clutch as well as a coupling to a transmission input, wherein the internal combustion engine is started by connecting the clutch, and wherein a mass energy of inertia released during the starting process is used for starting the internal combustion engine with a largely neutral torque.

19. The method according to claim 20, characterized by the fact that the internal combustion engine is started in the electric driving mode by connecting the clutch.

20. The method according to claim 1, characterized by the fact that the speed of the electric motor is lowered during the starting process in dependence on the transmission ratio, particularly by one-half.

21. The method according to claim 1, characterized by the fact that the speed of the internal combustion engine is varied by adjusting the speed of the electric motor.

22. The method according to claim 1, characterized by the fact that the speed of the transmission input of the automatic transmission is varied by adjusting the speed of the electric motor.

23. The method according to claim 1, characterized by the fact that a clutch arranged between a transmission input of the automatic transmission and the planetary gear is connected after the speed of the electric motor was varied, preferably increased, particularly to such a degree that it at least approximately corresponds to the speed of the internal combustion engine.

24. The method according to claim 1, characterized by the fact that the electric motor is used as a generator.

25. The method according to claim 1, characterized by the fact that the automatic transmission is down-shifted and the speed of the electric motor is increased for a regenerative braking maneuver.

26. The method according to claim 1, characterized by the fact that a change in the rotating direction of a transmission input of the automatic transmission is achieved by varying the speed of the electric motor until the transmission input changes the rotating direction.

27. The method according to claim 1, characterized by the fact that the hybrid engine is used in a vehicle, particularly a land craft.
